(19) United States
(12) Patent Application Publication
(10) Pub. No.: US 2006/0033826 A1
(43) Pub. Date: Feb. 16, 2006

(54) Imaging array having variable pixel size

(76) Inventors: Xinqiao Liu, San Jose, CA (US); David D. Wen, Los Altos, CA (US); Anh N. Vu, Saratoga, CA (US); Steven Kiyoshi Onishi, San Jose, CA (US); Charles J. Arduini, Santa Clara, CA (US)

Correspondence Address: The Law Offices of Calvin B. Ward, Suite 305, 18 Crow Canyon Court, San Ramon, CA, 94583, US

(21) Appl. No.: 10/918,628

(22) Filed: Aug. 12, 2004

(51) Int. Cl. H04N 5/217; H04N 3/14; H04N 5/335

(52) U.S. Cl. 348/294; 348/300

(57) ABSTRACT

The present invention includes an imaging apparatus having an imaging array, readout amplifier, and controller. The imaging array includes a plurality of pixels that accumulate charge when exposed to light. The readout amplifier receives charge from the pixels and generates a pixel signal indicative of the amount of charge received. The controller causes the charge from a plurality of the pixels to be added together to form a sum charge that is received by the readout amplifier. The imaging array can include a plurality of columns of pixels, and the controller causes the charge from a plurality of pixels in one of the columns to be added together to form a partial sum charge that is included in the sum charge. The readout amplifier can include a horizontal shift register, and the partial sum charge can be generated in the shift cells.

### BACKGROUND OF THE INVENTION

The present invention may be more easily understood in the context of low light imaging arrays such as those used in digital photography to record an image. For the purposes of this discussion, an image will be defined as a two-dimensional array of digital values that represent the amount of light received during an exposure period at each pixel on a two-dimensional surface onto which the image is projected. For the purposes of this discussion, it will be assumed that each pixel is a small rectangular area on that surface. In digital photography, the image is projected onto an imaging array in which each pixel includes a photodetector that measures the amount of light that falls on some portion of the pixel area.

The quality of the image is set by the signal-to-noise ratio at each pixel. The signal is proportional to the number of photons that were converted to electrons at that pixel. As the light levels in the image decrease, i.e., low light applications, the number of available photons at each pixel eventually becomes the limiting factor.

Hence, the pixel parameters must be chosen to assure that a sufficient number of photons are converted at each pixel location. The number of photons that are converted at each pixel depends on the exposure time, the pixel area, and the probability that a photon striking the active part of the pixel actually generates an electron that is captured by the photodetector. There is an upper limit on the exposure time that is set by the scene being imaged. The exposure time must be sufficiently small to “freeze” any motion in the scene. The probability that a photon will be converted to an electron is a property of the material from which the array is constructed, and hence, is not easily changed. Hence, to reduce the statistical noise, the pixel area must be increased when the light level is low. Since cameras, in general, have fixed pixel areas, the only practical method for changing the pixel area is to combine the output of several pixels to provide a signal indicative of the photons that would have been received by the larger pixel.

In prior art imaging arrays, the charge converted at each pixel is converted to a current or voltage by an amplifier that operates on the charge generated by that pixel. This collection of output currents or voltages is a representation of the image. While the amplifier output for a number of adjacent pixels can be combined to provide a signal indicative of the light received by a “super pixel” having the area of the pixels whose outputs were so combined, this approach has problems in low light situations. The amplifier and the electronics associated therewith, are another significant source of noise at the low charge values associated with low light imaging. Hence, the pixel values are corrupted by a second significant noise source. When the amplifier noise becomes a significant fraction of the statistical noise, adding together four pixel output values to provide a “super pixel” value will lead to a result that has a signal-to-noise ratio that is significantly less than the result that would have been obtained by adding together the four charges accumulated at each pixel and then converting that charge to an output value.

### SUMMARY OF THE INVENTION

The present invention includes an imaging apparatus having an imaging array, readout amplifier, and controller. The imaging array includes a plurality of pixels that accumulate charge when exposed to light. The readout amplifier receives charge from the pixels and generates a pixel signal indicative of the amount of charge received. The controller causes the charge from a plurality of the pixels to be added together to form a sum charge that is received by the readout amplifier. In one embodiment, the imaging array includes a plurality of columns of pixels, and the controller causes the charge from a plurality of pixels in one of the columns to be added together to form a partial sum charge that is included in the sum charge. In one embodiment, the readout amplifier includes a horizontal shift register having a plurality of shift cells, each shift cell corresponding to one of the columns of pixels, and the controller causes the partial sum charge to be generated in the shift cell corresponding to the one of the columns. In one embodiment, the controller causes the charge in a plurality of the shift cells to be added together to form the sum charge. In one embodiment, the columns of pixels include shift registers for shifting the charge into the shift cells of the horizontal shift register, and the controller causes the partial sum charge to be generated by causing a plurality of the charges in each of the columns to be shifted into the shift cells corresponding to each of the columns.

### BRIEF DESCRIPTION OF THE DRAWINGS

FIG. 1 illustrates a CCD imaging sensor according to one embodiment of the present invention.

FIG. 2 is a cross-sectional view of a portion of column 37, shown in FIG. 1, through line 2-2′.

FIG. 3 illustrates an imaging array 100 that can be divided into super pixels.

FIG. 4 is a schematic drawing of an output amplifier according to one embodiment of the present invention.

### DETAILED DESCRIPTION OF THE PREFERRED EMBODIMENTS OF THE INVENTION

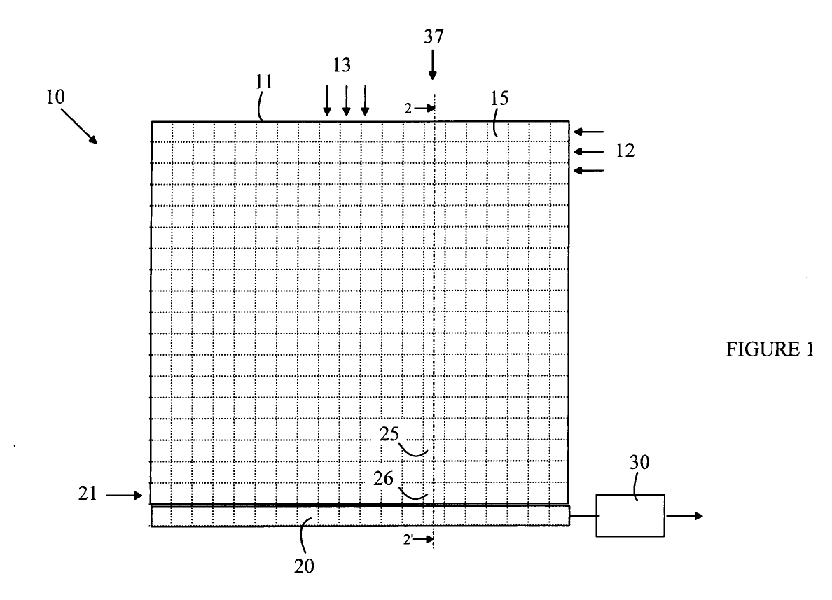

The manner in which the present invention provides its advantages can be more easily understood with reference to FIG. 1, which illustrates a CCD imaging sensor according to one embodiment of the present invention. Image sensor 10 includes a photodetector array 11 in which the individual photodetectors 15 are organized as a plurality of rows 12 and columns 13. In addition, the columns can be operated as shift registers to move charge stored in the various photodetectors after the array is exposed to an image, to a shift register 20. On each single column shift operation, the contents of the photodetectors in row 21 are shifted into register 20, and the contents of each column are moved downward toward shift register 20. The contents of shift register 20 are then shifted horizontally into an output amplifier 30 that converts the charge in cell 25 to an output voltage. To simplify the drawing, the various electrodes used in the shifting operations and the clock circuitry have been omitted from FIG. 1.

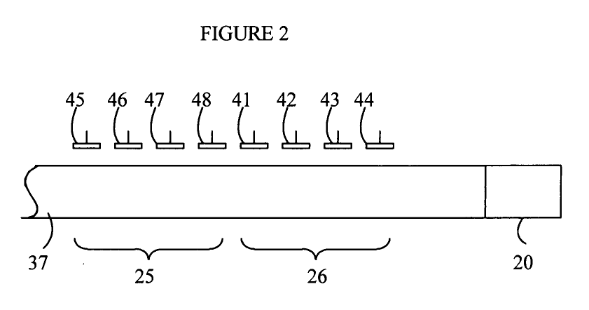

Refer now to FIG. 2, which is a cross-sectional view of a portion of column 37 through line 2-2′. The portion shown in the figure includes the last two photodetectors and the electrodes associated therewith. The electrodes divide the column into the individual photodetectors by creating potential barriers at predetermined locations along the column. The position of these barriers is determined by the potentials applied to the electrodes. During the period in which the image sensor is being exposed to an image, these barriers remain fixed and electrons generated by the interaction of the light and the column material remain trapped within the pixel areas defined by these barriers. When data is to be shifted toward shift register 20, the potentials on these electrodes is cycled in a manner that causes the charge in each pixel area to be moved into the adjacent pixel area. The charge in pixel 26 is then moved into shift register 20.

The manner in which the charge is shifted along column 37 is known to the art, and hence, will not be discussed in detail here. For the purposes of this discussion, it is sufficient to note that each pixel cell in column 37 includes an area of silicon in which the charge moves, and 4 electrodes that set the potential in the silicon area. Two such cells are shown at 25 and 26. The electrodes over the silicon of cell 26 are shown at 41-44. At the start of a shift cycle, the electrodes 41 and 44 are at potentials that contain the charge in the region under electrodes 42 and 43. To move the charge into shift register 20, the potential at electrode 42 is altered to force the charge into the region under electrode 44. The potential on electrode 44 is then altered to allow the charge to escape into a corresponding cell in shift register 20. The potential on electrodes 43 and 44 is then sequentially altered to force the charge under these electrodes to move into shift register 20.

During the shift operation, the potentials on electrodes 45-48 associated with cell 25 are likewise manipulated to force the charge in that cell into cell 26. For example, when the potential on electrode 42 is altered to force charge under that electrode to the area under electrode 43, electrode 41 is no longer needed to contain the charge within cell 26. Hence, the potential on this electrode can be altered to allow charge from cell 25 to move under electrode 41. Similarly, when the potential on electrode 43 is altered to move the charge under electrode 44, the potential on electrode 42 is no longer needed to separate the charge in cells 25 and 26, and hence this electrode's potential can be altered to allow the charge from cell 25 to move under that electrode. The potential on the electrodes in cell 25 can then be altered to force the remaining charge from cell 25 to move under electrode 43 thereby completing the shifting of the charge from cell 25 to cell 26 while the charge from cell 26 was shifted into shift register 20.

Charge is shifted along shift register 20 in an analogous manner. Each time one row in array 11 is shifted downward, shift register 20 is filled. The contents of shift register 20 are then shifted into amplifier 30, one cell at a time. The amplifier converts the charge from each cell into a corresponding voltage that is read from amplifier 30 by an output circuit. To simplify the drawings, the output circuit and the controller for operating the electrodes have been omitted from FIGS. 1 and 2. After the amplifier voltage has been recorded, the amplifier is reset, and the next cell's charge is shifted into the amplifier. When the contents of all of the cells of shift register 20 have been readout, the charges stored in the next row of pixels is shifted into shift register 20, and the process is repeated.

The charge accumulated in each pixel cell during the exposure phase of the image capture depends on the intensity of the light received by that pixel cell. As noted above, if the light levels are low, the number of electrons accumulated in each pixel cell is too small, and the statistical errors result in an unsatisfactory image. The present invention is based on the observation that an image having lower spatial resolution but higher statistical accuracy is often more satisfactory than an image having the higher spatial resolution. In effect, the present invention allows the imaging array to be reconfigured such that each pixel cell occupies an area that is a multiple of the original pixel cell area. Since the number of electrons accumulated during the exposure phase is proportional to the pixel cell area, the resulting image has higher statistical accuracy. The higher accuracy is obtained at the expense of the image spatial resolution.

If the readout amplifier was noise free, this coarser image could be obtained by adding the voltages obtained from blocks of adjacent pixel cells after the charge from each pixel cell was converted to a voltage. However, as noted above, the amplifiers used in CCD imaging arrays have a significant level of noise, and hence, this process leads to an image that has a higher level of noise than an image that would be obtained if the pixel cells had the same area as that of the blocks of adjacent cells. The present invention overcomes this problem by combining the charges generated in blocks of adjacent pixel cells to provide a summed charge that is then converted by the output amplifier.

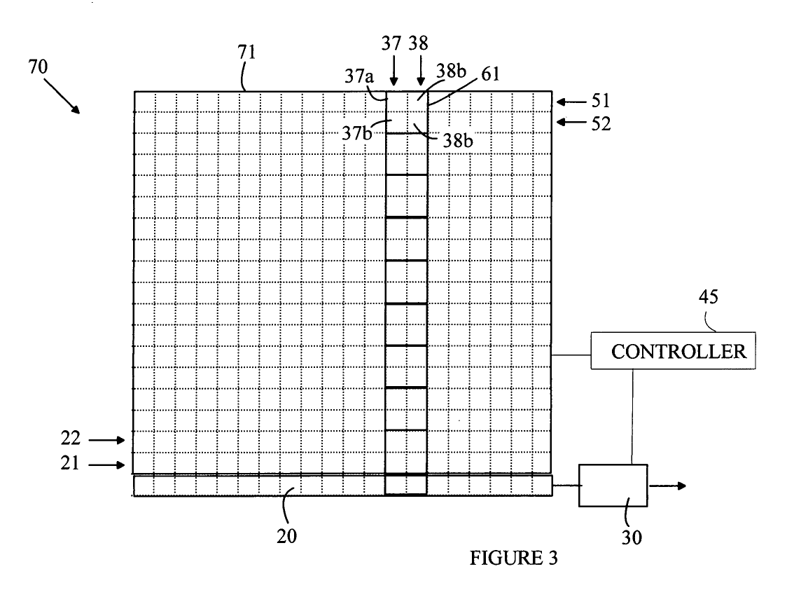

To simplify the following discussion, “super pixel” will be used to denote the area in the image array covered by a number of adjacent pixels. Refer to FIG. 3, which illustrates an imaging array 70 that can be divided into super pixels. Imaging array 70 includes a photodetector array 71 that is divided into pixels. In the example shown in FIG. 3, a super pixel consisting of groups of 4 adjacent pixels is shown at 61. Super pixel 61 includes two pixels from column 37 and two pixels from column 38. The pixels in question are located in rows 51 and 52. The charge from supper pixel 61 is obtained by combining the charges accumulated in pixels 37a and 37b and the charges accumulated in pixels 38a and 38b. These two combined charges are then combined to provide the charge from the super pixel. The various shifting operations are controlled by controller 45.

In one embodiment of the present invention, the charges in the respective columns are combined when the charges are transferred from the columns to shift register 20. The combined charges from each column are then combined in shift register 20 to provide the charge corresponding to each super pixel. In normal mode, the charge is shifted such that each row is shifted downward. The charge from row 21 is shifted into shift register 20 by this operation and the charge from row 22 enters row 21. The charge in shift register 20 is then shifted into amplifier 30 one cell at a time.

In super pixel mode, multiple rows are shifted into shift register 20 before the contents of shift register 20 are shifted into amplifier 30. In the example shown in FIG. 3, the charge from row 21 is shifted into shift register 20. The charge from row 22 is left in row 21 after this shift operation. A second shift operation is then performed to move the charge that is now in row 21 into shift register 20. At the end of this double shift, the charge in each cell in shift register 20 is the sum of the charges in two pixel cells in the corresponding columns.

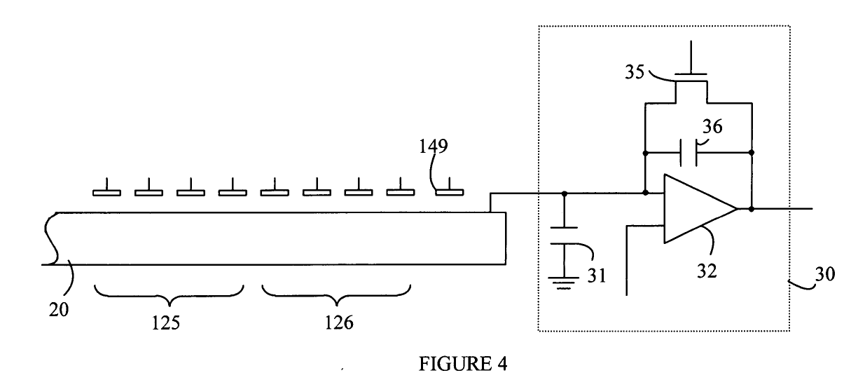

In one embodiment of the present invention, the charge combining operation for the contents of shift register 20 is carried out at amplifier 30. Refer now to FIG. 4, which is a schematic drawing of an output amplifier, according to one embodiment of the present invention, connected to the last two shift cells 125 and 126 in shift register 20. Shift register 20 shifts charge from one storage cell to the next in a manner analogous to that discussed above with respect to the manner in which charge is shifted out of the various columns.

Output amplifier 30 has one capacitor 31 at the input of an operational amplifier 32 and another capacitor 36 between the input and output of the operational amplifier 32. During readout, the charge from cell 126 will be shifted onto capacitor 31, and then onto capacitor 36 since the voltage on capacitor 31 can not be changed due to the high gain of operational amplifier 32. After the charge is shifted onto 36, operational amplifier 32 converts the charge to a voltage value that can then be digitized to provide the intensity value corresponding to the pixel in which the charge was originally generated. Prior to the charge from cell 126 being shifted onto capacitor 31, the potential across 36 is set to a predetermined value. This is accomplished by applying a reset control signal to transistor 35, which couples the input of operational amplifier 32 to its output, which is held at the reset potential during this operation. Once the potential on capacitor 36 has been set, transistor 35 is set to the non-conducting state. When the charge from cell 126 is shifted onto capacitor 36, it alters the voltage at the output of operational amplifier 32. Since capacitor 36 effectively integrates the charge deposited thereon, the summing operation for the cells in shift register 20 can be carried out by shifting the charge from each cell to be summed onto capacitor 36 after the capacitor has been reset. Once all of the charges have been shifted onto capacitor 36, the voltage at the output of operational amplifier 32 provides a measure of the sum of the charge from the cells in question.

It should be noted that the potential on electrode 149, which acts as an output gate, is maintained at a constant potential except when charge is to be transferred to capacitor 31. This output gate reduces clock coupling between the other electrodes and capacitor 31.

The above-described embodiment implemented a 2×2 super pixel. However, embodiments that implement an N×M super pixel can be constructed in a similar manner. In fact, since the summing is performed at the end of the columns and as the vertically summed pixels are shifted onto capacitor 31, the super pixel size can, in principle, be varied over the image. In such an embodiment, a short test exposure can be used to determine which regions of the image require summing. For example, controller 45 shown in FIG. 3 can record the first image and then decide which areas require summing in the second image. Controller 45 would then alter the shift cycles so that the pixels in the desired rows and columns are summed. Since all of the column pixels are normally shifted together, there are some limitations on the variation in super pixel resolution over the image.

In principle, the summation in the columns can be accomplished by connecting adjacent electrodes to each other. For example, to construct a 2×2 super pixel, each pair of adjacent electrodes could be connected together such that a series of 8 electrodes are used for each column cell instead of the 4 discussed above. This provides a cell that has 4 electrodes that are twice as large in the column direction. Such an embodiment would have the advantage of requiring fewer individual shift operations, and hence, would have a shorter read-out time.

Unfortunately, the limitations on the circuitry that can be constructed on the image array itself make such embodiments more difficult to construct. To implement such an embodiment, the individual row electrodes would need to be separately accessible so that the connections can be reconfigured in response to changes in the super pixel size. Hence, circuitry must be provided at the end of each row electrode for making these connections. That circuitry must either be on the same silicon substrate on which the photodetection array is constructed or on a second substrate that is attached to the first substrate. While such circuitry is relatively easy to construct using CMOS or some similar fabrication technique, it is difficult to implement in the process used for making the detection array.

Hence, such circuit functions are preferably placed on separate substrates. For example, the readout circuitry discussed above can be placed on a first substrate that contains CMOS circuitry while the imaging array is placed on a second substrate. In the case of the row electrodes, a connection would need to be made for each row electrode between the detection array and the adjacent logic substrate. Given the large number of row electrodes and their close spacing, such connections are difficult to implement.

It should be noted that conventional CCD arrays have row electrodes that are connected in parallel. That is, the first electrodes in each vertical cell are all connected together; the second electrodes are connected together, and so on. Hence, only 4 connections are needed between the logic substrate and the photodetection array substrate. Accordingly, embodiments in which the summing is performed at the horizontal shift register and output amplifier avoid this problem.

It should be noted also that the above described output amplifier and its associated capacitors 31 and 36 can be implemented on a different substrate, and the charge can be transferred from the photodetection array substrate onto the amplifier substrate via electrical connections. Further, the number of amplifiers implemented on the second substrate can be more than one, in which case the horizontal shift register 20 can be divided into multiple pieces, and each piece will be connected to one amplifier.

The above-described embodiments of the present invention have utilized 4 phase shift registers. However, the present invention can be applied to CCD arrays using other numbers of electrodes per cell. For example, CCD arrays utilizing two and three phase shift registers are known to the art. In embodiments in which the summation is performed at the point at which the vertical column cells enter the horizontal shift register and the point at which the horizontal shift register contents are shifted into the output amplifier, the present invention operates in the same manner as that discussed above. For example, in a 2×2 super pixel implementation, the controller shifts two column cells into each cell in the horizontal register before shifting the horizontal register into the output circuit. This is equivalent to inhibiting every other horizontal shift cycle. Similarly, the summation of the cells in the horizontal shift register is equivalent to inhibiting every other output measurement. Such inhibition operations are independent of the specific details of the electrodes in the column shift registers.

Various modifications to the present invention will become apparent to those skilled in the art from the foregoing description and accompanying drawings. Accordingly, the present invention is to be limited solely by the scope of the following claims.

What is claimed is:

1. An imaging apparatus comprising:
an imaging array comprising a plurality of pixels that accumulate charge when exposed to light;
a readout amplifier that receives charge from said pixels and generates a pixel signal indicative of the amount of charge received; and
a controller that causes said charge from a plurality of said pixels to be added together to form a sum charge that is received by said readout amplifier.

2. The imaging apparatus of claim 1 wherein said imaging array comprises a plurality of columns of pixels, and wherein said controller causes said charge from a plurality of pixels in one of said columns to be added together to form a partial sum charge, said sum charge comprising said first partial sum charge.

3. The imaging apparatus of claim 2 wherein said readout amplifier comprises a horizontal shift register having a plurality of shift cells, each shift cell corresponding to one of said columns of pixels and wherein said controller causes said partial sum charge to be generated in said shift cell corresponding to said one of said columns.

4. The imaging apparatus of claim 3 wherein said controller causes said charge in a plurality of said shift cells to be added together to form said sum charge.

5. The imaging apparatus of claim 3 wherein said columns of pixels comprise shift registers for shifting said charge into said shift cells of said horizontal shift register and wherein said controller causes said partial sum charge to be generated by causing a plurality of said charges in each of said columns to be shifted into said shift cells corresponding to each of said columns.

6. The imaging apparatus of claim 5 wherein said readout amplifier sums a plurality of said partial sum charges.

7. The imaging apparatus of claim 1 wherein said imaging array is a CCD imaging array.

8. The imaging array of claim 7, wherein said readout amplifier is located on a first substrate and said CCD imaging array is located on a second substrate.

9. The imaging array of claim 8 wherein said controller is located on said first substrate.

10. The imaging array of claim 8 wherein said readout amplifier comprises a CMOS circuit.

11. A method for operating an imaging apparatus to provide variable resolution, said method comprising:
providing a imaging array comprising a plurality of pixels that accumulate charge when exposed to light; and
causing said charge from a plurality of said pixels to be added together to form a sum charge; and
generating a signal indicative of said sum charge.

12. The method of claim 11 wherein said imaging array comprises a plurality of columns of pixels, and wherein said charge from a plurality of pixels in one of said columns is added together to form a partial sum charge, said sum charge comprising said first partial sum charge.

13. The method of claim 12 wherein said imaging apparatus comprises a horizontal shift register having a plurality of shift cells, each shift cell corresponding to one of said columns of pixels and said partial sum charge is generated in said shift cell corresponding to said one of said columns.

14. The method of claim 13 wherein said charge in a plurality of said shift cells is added together to form said sum charge.

15. The method of claim 13 wherein said columns of pixels comprise shift registers for shifting said charge into said shift cells of said horizontal shift register and wherein said partial sum charge is generated by causing a plurality of said charges in each of said columns to be shifted into said shift cells corresponding to each of said columns.

16. The method of claim 15 further comprising summing a plurality of said partial sum charges.

17. The method of claim 11 wherein said imaging array is a CCD imaging array.

18. The method of claim 17, wherein said readout amplifier is located on a first substrate and said CCD imaging array is located on a second substrate.

19. The method of claim 18 wherein said controller is located on said first substrate.

20. The method of claim 18 wherein said readout amplifier comprises a CMOS circuit.
